(19) United States
(12) Patent Application Publication
(10) Pub. No.: US 2003/0179810 A1
(43) Pub. Date: Sep. 25, 2003

(54) CODER AND CODING METHOD FOR USE IN SPREAD SPECTRUM COMMUNICATIONS SYSTEMS

(76) Inventors: JOHN ERIK HERSHEY, BALLSTON LAKE, NY (US); GARY JUDE SAULNIER, REXFORD, NY (US); RICHARD AUGUST KORKOSZ, ROTTERDAM JUNCTION, NY (US); KENNETH BARKELEY WELLES II, SCOTIA, NY (US); RICHARD CHARLES GUAS JR., BURNT HILLS, NY (US); NAOFAL MOHAMMED WASSEL AL-DHAHIR, NISKAYUNA, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/347,560

(22) Filed: Jul. 6, 1999

(51) Int. Cl. H04B 1/69

(52) U.S. Cl. 375/130

(57) ABSTRACT

The present invention is a coder for encoding and decoding a digital baseband signal in spread spectrum communication system such that the phase integrity of the carrier inversions is preserved. The coder comprises an encoder and a decoder. The encoder includes an exclusive “or” logic unit and a delay unit. The exclusive “or” logic unit includes a first input for receiving the baseband digital signal to be encoded. The one bit delay unit includes an input coupled to the output of the exclusive “or” logic unit. The one bit delay unit further includes an output coupled to a second input of the exclusive “or” logic unit. The undelayed output of the exclusive “or” logic unit provides the encoded digital baseband signal. The encoded digital baseband signal is utilized to modulate a spread spectrum carrier signal.

### BACKGROUND OF THE INVENTION

This invention relates to spread spectrum communication systems and more particularly, to a coder for encoding a digital baseband signal and decoding a spread spectrum carrier modulated by the encoded digital baseband signal.

Spread spectrum communication techniques are those in which the bandwidth occupied by the transmitted signal is greater than the bandwidth required by the baseband signal. The transmitted signal comprises a wide bandwidth carrier signal modulated by the lower bandwidth baseband signal. The baseband signal comprises binary data representing a message, or other information to be communicated on the system.

Geometric Harmonic Modulation (GHM), is a simplified spread spectrum method of modulating a wide bandwidth carrier signal. Generally, GHM allocates signaling energy into lobes, or tones, comprising different carrier frequencies evenly spaced. The transmitted GHM signal is a true spread spectrum signal in that the carrier bandwidth, i.e., the bandwidth from the lowest transmitted carrier frequency tone to the highest, exceeds the bandwidth of the baseband binary data which modulates the carrier. GHM is particularly useful for applications such as automated meter reading and other applications wherein information is transmitted via a power line. GHM is described, for example, in Hershey et al., U.S. Pat. No. 5,519,725, which is assigned to the present assignee and hereby incorporated herein, in its entirety, by reference.

Power distribution networks typically include primary power lines and secondary power lines. Distribution transformers couple the primary lines to the secondary lines, and step-down the voltage level from the primary to secondary lines. Difficulties have been encountered in attempting to pass spread spectrum communications signals, including GHM signals, over power grids, including distribution transformers and other sources of phase shifts. The difficulty is related to the use of phase modulation techniques in which the baseband signal modulates the carrier signal by causing a phase shift of all carrier frequencies for a period of one data bit. The phase shift is such that the carrier waverform is inverted for a data bit value of one, and not inverted for a data bit value of zero, or vice versa.

Unfortunately, upon passage through a power grid system including, for example, a distribution transformer, the transmitted signal is subject to a time varying transfer function that is non linear in phase. This frequently results in an undesirable further phase shift in the transmitted data that can obscure information contained in the phase inversions of the carrier signal. In addition, a timing offset may be introduced by the propagation of a 60 Hz synchronization signal through the distribution transformer. The transfer function and timing offset impact the accuracy and integrity of phase sensitive signals communicated on the power lines.

Therefore, a need exists for systems and methods of transmitting communications signals, such as GHM signals, through power lines which overcome the obstacles presented by sources of phase shift, such as distribution transformers, in the communications path and which preserve the integrity of the information conveyed in the phase shifts of the carrier signal.

### BRIEF SUMMARY OF THE INVENTION

The present invention provides a coder for encoding and decoding a digital baseband signal and a spread spectrum communication system encompassing such a coder. The coder comprises an encoder and a decoder. The encoder includes an exclusive “or” logic unit and a delay unit. The exclusive “or” logic unit includes a first input for receiving the baseband digital signal to be encoded. The one bit delay unit includes an input coupled to the output of the exclusive “or” logic unit. The one bit delay unit further includes an output coupled to a second input of the exclusive “or” logic unit. The undelayed output of the exclusive “or” logic unit provides the encoded digital baseband signal.

### BRIEF DESCRIPTION OF THE DRAWINGS

FIG. 1 is a block diagram of an encoder in accordance with one embodiment of the present invention.

FIG. 2 is a block diagram of a decoder in accordance with one embodiment of the present invention.

FIG. 3 is a block diagram of a power line interface utilized in connection with the encoder and decoder described in connection with FIGS. 1 and 2, respectively

### DETAILED DESCRIPTION OF THE INVENTION

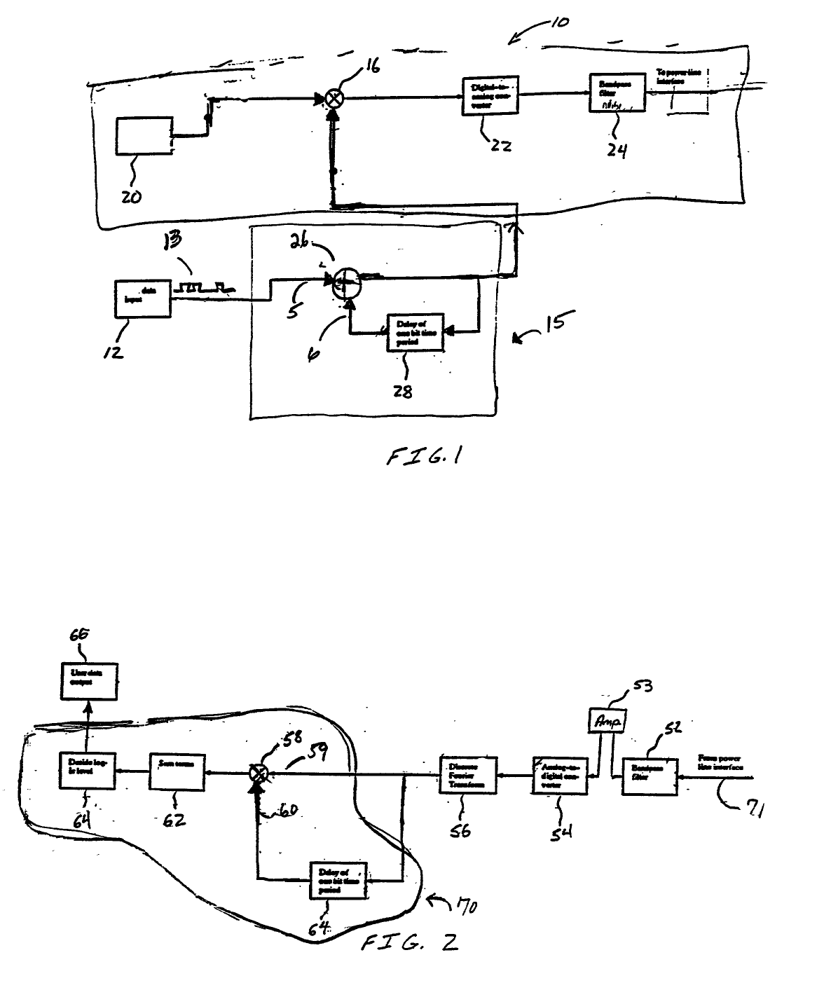

FIGS. 1 and 2 together illustrate an encoder 15 and a decoder 70 comprising a coder 10 for use in conjunction with a spread spectrum communication system, such as a GHM system. FIG. 1 illustrates an encoder 15 for a spread spectrum communication system 10 in accordance with one embodiment of the present invention. A binary message 13 to be transmitted is provided by data input source 12. Data input source 12 can be any source of binary information, commands or data supplied in digital format. In one embodiment of the invention, data source 12 is a memory in which is stored commands to be transmitted to a remote location via a power line in order to control an electronic device such as a switch. In another embodiment of the invention, data source 12 is an electric meter configured to provide a meter reading in digital format such that the reading may be sent from a user of electric power to a central computer of a utility company.

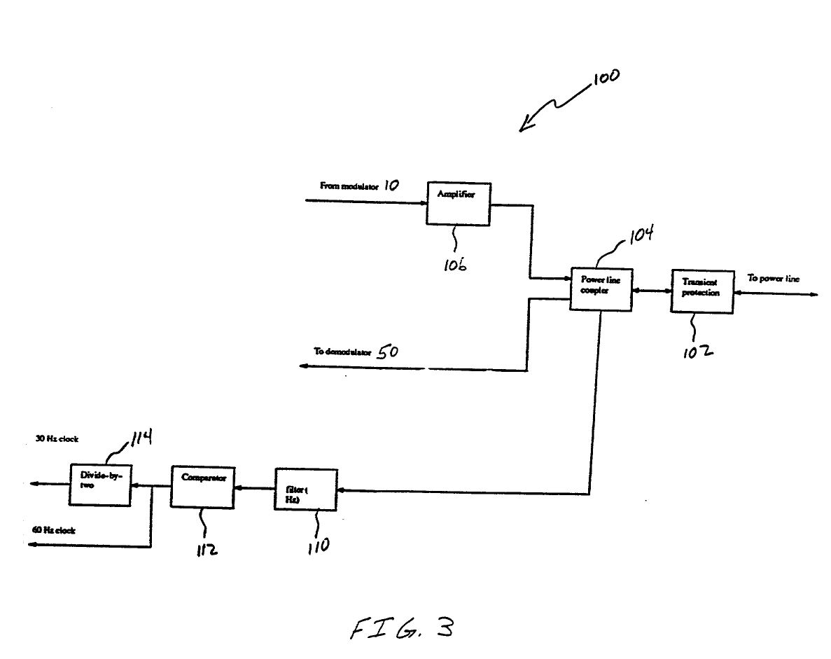

A typical spread spectrum system 10 comprises a generator 20 for generating spread spectrum carrier signals, such as GHM signals or spreading codes, a modulator 16 such as a multiplier, for modulating the carrier with a data signal, a digital to analog converter 22, and a bandpass filter 24. In one embodiment of the generator 20 generates GHM signals according to techniques described in U.S. Pat. No. 5,519,725, incorporated by reference hereinabove. In GHM applications for communicating via a power line, a power line coupler (best illustrated in FIG. 3) is employed to couple the spread spectrum signal to and from a power line.

As opposed to conventional systems in which binary data 13 would be supplied directly to modulator 16, binary data 13, according to the present invention, is supplied to encoder 15. The output of coder 15 is supplied to modulator 16, which is a multiplier in the embodiment of the invention illustrated in FIG. 1.

Encoder 15 comprises an exclusive “or” logic unit 26 and a one bit delayer 28. Data source 12 is coupled to a first input 5 of exclusive “or” logic unit 26. The output of exclusive “or” logic unit 26 is provided to modulator 16 and at the same time provided to one bit delayer 28. The output of delayer 28 is coupled to a second input 6 of exclusive “or” logic unit 26 such that undelayed data 13 from data source 12 and the one bit delayed data are exclusive “or'ed”. The data bits output by exclusive “or” logic unit 26, which are signed data bits in one embodiment of the invention, are supplied to the modulator 16 of typical spread spectrum communication system 10, thereby modulating the spread spectrum carrier signal generated by generator 20.

Modulator 16 combines the outputs of encoder 15 and generator 20. In one embodiment of the invention, modulator 16 is a multiplier which generates the dot product of each discrete frequency component generated by generator 20 and the digital signal provided at the output of exclusive “or” unit 26. In another embodiment of the invention, modulator 16 provides the dot product of the spreading code generated by generator 20 and the digital signal output of exclusive “or” unit 26. Modulator 16 provides a modulated carrier signal to digital to analog converter 22. The signal is converted to analog form, passed through a bandpass filter 24, and supplied to a power line interface for coupling to, and transmission via the power line.

FIG. 2 illustrates a decoder 70 used in conjunction with a GHM demodulator 50 in accordance with one embodiment of the present invention. Demodulator 50, except for decoder 70, is a typical GHM demodulator. Demodulator 50 receives signals from the power line and provides the received signal to bandpass filter 52. Bandpass filter 52 removes low frequency components of the received signal and passes the signal to amplifier 53 for amplification. Analog to Digital Converter 54 converts the analog data signals to digital form.

Discrete Fourier transform unit 56 performs a discrete fast Fourier transform (FFT) on the digital signal. Specifically, a complex FFT over one symbol duration, which is the time duration of a 60 Hz cycle, is repeatedly obtained. In one embodiment of the invention, the FFT sampling times are derived from a filtered sampling signal which is effectively tied to the short term average of the positive going zero crossing of the 60 Hz waveform, i.e., the primary signal on the power line.

In an example of one embodiment of the invention, transform unit 56 employs M=2ⁿ FFT bins for a geometric harmonic modulated (GHM) signal of order n, n being the number of discrete frequency components of the GHM signal. The 2ⁿ bins are distributed throughout the portion of the usable communications spectrum over which a P=2ⁿ point FFT is obtained, wherein p>n, and wherein P is the number of points in the FFT. Transform unit 56 retains, conjugates and stores in memory, the M complex FFT coefficients for the sampling done over the symbol time interval τ.

The output of transform unit 56, in addition to being supplied directly to multiplier 58, is supplied to decoder 70. Decoder 70 comprises a one bit delay unit 64. Delay unit 64 delays the input by one bit and provides the delayed output to multiplier 58. In one embodiment of the invention, multiplier 58 generates the dot product of the one bit delayed signal and the original signal at each discrete frequency component of the spread spectrum input signal. In one embodiment of the invention, the coefficients are multiplied at a symbol time interval of τ+1.

Summer 62 sums the output from multiplier 58, and provides a summed output Z to logic level determiner 64. Logic level determiner 64 determines the logic level of the summed output Z, thereby recovering the transmitted binary data. In one embodiment of the invention, if Z is greater than or equal to zero, Logic level determiner 64 determines that a logical zero has been sent. Otherwise, it is determined that a logical one has been sent. After the logic level is determined the data is supplied to an output 66.

FIG. 3 is one example of a power line interface 100 for use in connection with modulator 10 and demodulator 50. Particularly, interface 100 is coupled to a power line and includes transient protection 102 and a power line coupler 104. If data is transmitted from modulator 10, the data is amplified by amplifier 106 and supplied to coupler 104. If data is being received by demodulator 50, the data is supplied to demodulator 50 from coupler 104.

For timing purposes, the signal from coupler 104 is supplied to a lowpass filter 110. In one embodiment of the invention lowpass filter 110 has a cutoff frequency of about 90 Hz. The output of lowpass filter 110 is provided to a comparator 112. The output of comparator 112 is a 60 Hz square wave clock signal. In one embodiment of the invention the 60 Hz clock signal is divided by two in a divider 114 to generate a 30 Hz clock signal. The clock signals are utilized for establishing the data rate and for resynchronizing the sampling clocks for the converters.

Encoder 15, spread spectrum system 10, demodulator 50, decoder 70 and power line interface 100 are processor-based units. The individual components of each of these are typical of those used in the art and are readily commercially available.

Use of the above described encoder and decoder facilitates identification of transmission errors which result from the time varying transfer function due to transmission through distribution transformers and from the small timing offset introduced by the propagation of the 60 Hz synchronization signal. By facilitating the prompt identification of such errors, data signals having such errors are retransmitted so that the correct data is received. In addition, the above described encoder and decoder provide spread spectrum signaling, based on GHM techniques.

A method for coding a digital baseband signal in a spread spectrum communications system comprises the steps of encoding a digital baseband signal by providing the digital baseband signal to a first input of an exclusive “or” unit. The output of the exclusive “or” unit is delayed, and the delayed output fed back to a second input of the exclusive “or” unit. The undelayed output of the exclusive “or” unit provides a coded digital baseband signal. In one embodiment of the invention, the coded digital baseband signal is utilized to modulate a spread spectrum carrier signal. In one embodiment of the invention the modulated spread spectrum carrier signal is then coupled to a power line via a power line coupler and conveyed via the power line to a decoder, where the spread spectrum carrier signal is decoupled from the power line, Fourier transformed, and decoded.

The method of decoding includes the steps of delaying the Fourier transformed carrier signals and multiplying the delayed Fourier transformed carrier signals by the undelayed Fourier transformed signals. The product is summed and the logic level of the output of the summer is determined. The output of the summer is the decoded digital baseband signal. In one embodiment of the method of the invention, if the output of the summer is greater than zero, a logic one is declared. If the output of the summer is zero or less, a logic zero is declared. An alternative embodiment of the invention employs the opposite scheme. That is if the output of the summer is zero or less a logic one is declared, and if the output is greater than zero a logic one is declared. Other schemes for declaring a logic one or zero are possible and all fall within the scope of the present invention.

Of course, many variations of the foregoing system and method are possible. For example, an embodiment employing an FFT with a resolution finer than 30 Hz better separates the signaling components of the GHM from the noise harmonics of the 60 Hz primary signal. Also, an embodiment of the invention employing a shaping window in connection with the GHM signal components reduces the spectral overlap of the GHM spectrum with the noise harmonic power spectrum.

While the invention has been described in terms of various specific embodiments, those skilled in the art will recognize that the invention can be practiced with modification within the spirit and scope of the claims.

What is claimed is:

1. An encoder for encoding a digital baseband signal in a spread spectrum communication system, said encoder comprising:
an exclusive “or” logic unit having a first input for receiving said digital baseband signal;
a one bit delay unit having an input coupled to the output of said exclusive “or” logic unit, said one bit delay unit having an output coupled to a second input of said exclusive “or” logic unit;
the output of said exclusive “or” logic unit providing an encoded digital baseband signal;
said encoded digital baseband signal coupled to a modulator so as to modulate spread spectrum carrier signal.

2. An encoder according to claim 1 wherein said spread spectrum communication system is a geometric harmonic modulation communication system.

3. A decoder for decoding a digital baseband signal recovered from a geometric harmonic modulation spread spectrum communication signal said decoder comprising:
a one bit delay unit having an input coupled to the output of a geometric harmonic modulation Fourier transform unit;
a multiplier having a first input coupled to the output of said geometric harmonic modulation Fourier transform unit, and a second input coupled to the output of said one bit delay unit;
a summer coupled to the output of said multiplier;
a logic level determiner coupled to the output of said multiplier said logic level determiner to provide a decoded digital baseband signal.

4. A coder for a geometric harmonic modulation spread spectrum communication system, said coder comprising:
an encoder including:
an exclusive “or” logic unit having a first input for receiving a baseband digital signal;
a one bit delay unit having an input coupled to the output of said exclusive “or” logic unit;
said one bit delay unit having an output coupled to a second input of said exclusive “or” logic unit;
the output of said exclusive “or” logic unit providing an encoded digital baseband signal;
said encoded digital baseband signal modulating a spread spectrum carrier signal;
a decoder including:
a one bit delay unit having an input coupled to the output of a geometric harmonic modulation Fourier transform unit;
a multiplier having a first input coupled to the output of said geometric harmonic modulation Fourier transform unit, and a second input coupled to the output of said one bit delay unit;
a summer coupled to the output of said multiplier;
a logic level determiner coupled to the output of said summer said logic level determiner providing a decoded digital baseband signal at its output.

5. A coder according to claim 4 wherein the modulated spread spectrum carrier signal is coupled to a power line and wherein said power line is utilized to convey said encoded baseband signal information from said encoder to a receiver.

6. A method for encoding a digital baseband signal in a spread spectrum communications system, the method comprising the steps of:
providing said digital baseband signal to a first input of an exclusive “or” unit;
performing an exclusive “or” operation on said first input and a second input of said exclusive “or” unit;
delaying the output of said exclusive “or” unit and providing the delayed output to said second input of said exclusive “or” unit;
the undelayed output of said exclusive “or” unit being the encoded digital baseband signal.

7. The method of claim 6 further comprising the step of utilizing the encoded digital baseband output to modulate a spread spectrum carrier signal.

8. The method of claim 6 wherein the output of said exclusive “or” unit is delayed for one bit period.

9. The method of claim 7 wherein said modulated spread spectrum carrier is coupled to a power line.

10. A method of decoding a digital baseband signal encoded by the method of claim 6, when the encoded digital baseband signal modulates a geometric harmonic modulation carrier signal, the method comprising the steps of:
decomposing said geometric harmonic modulation signal into geometric harmonic modulation tones;
providing said geometric harmonic modulation tones to a first input of a multiplier;
delaying said geometric harmonic modulation tones and providing the delayed tones to a second input of said multiplier;
multiplying said first input by said second input to provide a product;
summing said product;
determining the logic level of said product, the determined logic level being the decoded digital baseband signal.

11. A method in accordance with claim 10 further comprising the steps of:
declaring a logical zero when said product is greater than or equal to zero, and
otherwise declaring a logical one.
